(19) United States
(12) Patent Application Publication
(10) Pub. No.: US 2011/0106283 A1
(43) Pub. Date: May 5, 2011

(54) Child's media player with automatic wireless synchronization from content servers with adult management and content creation

(75) Inventor: Michael J. Robinson, Seattle, WA (US)

(73) Assignee: Everhear Partners, Inc., Seattle, WA (US)

(21) Appl. No.: 12/930,037

(22) Filed: Dec. 27, 2010

Related U.S. Application Data
(63) Continuation of application No. PCT/US09/04026, filed on Jul. 11, 2009.
(60) Provisional application No. 61/134,914, filed on Jul. 14, 2008.

(51) Int. Cl. G06F 17/00; H04L 9/32

(52) U.S. Cl. 700/94; 726/5

(57) ABSTRACT

A system and method for remotely delivering customized content to children using a series of private libraries of digital content files (music files, video files, pictures, digital storybooks, and so on) stored on one or more servers, where the private libraries of digital content are managed by certain individuals (presumably adults) for the benefit of other individuals (presumably young children of the adults). This private library, called a “soundtrack” is then delivered to the recipient person for their listening and viewing by a variety of possible means, and ideally via a special purpose hand held media player which is specifically adapted to synchronize with the private library content on the server(s).

The present application is a continuation of PCT/US2009/004026 filed Jul. 11, 2009 and claims priority from U.S. Provisional Patent Application Ser. No. 61/134914, filed Jul. 14, 2008, which application is incorporated herein by reference in its entirety.

### BACKGROUND

Adults who must be away from home want to provide on-going contact to their children. A web server can allow adults to combine their own sound recordings with pre-existing sound recordings to create a combined soundtrack that is customized for a child and then can be delivered by CD, MP3 file, or other means. A specialized hand-held digital media player (akin to an iPod or MP3 player or memory enhanced mobile telephone)—can be used by children to play audio or audio/video output selected and/or created by adults. Prior art includes MP3 players, iPods, and iPhone. All these players synchronize manually via wired (USB) connection to a library on a local PC, managed via a single login interface.

### SUMMARY OF INVENTION

The invention is a system that allows adults to control the content and sequence of items played out of media players (recorded sound players) used by children, and optionally to record new content and/or personalize pre-existing commercial content. The media player used by the child need only have an on/off button or just a start button to initiate playing the next item in the sequence when the button is pushed. It may receive its content by periodic electrical coupling to a computer, or by a unicast radio link, which may be via cell phone network, wide area digital data network, or local radio computer network, or by a delivered compact disc (CD), digital video disk, (DVD), memory stick, SD card, or other physical memory.

The audio or audio/video materials to be played out are stored on servers in a library dedicated to a particular child that can be managed by one or more adults. For content items that are not unique to the child, the items in the library might be merely pointers or links to items in a library of generic items for many children. Each content item might be replicated into in a memory where it is stored in its entirety in the media player or might be streamed to the media player via a unicast radio communication link or other link and each byte is then stored in the media player only long enough to ensure it is played out as desired.

The system may allow two or more adults to have access credentials and independently select or provide content items to be played to the child. The content items from each adult may automatically be identified as coming from that adult by methods such as a recorded sound introduction, an audiocon (a sound that represents the person), or an image identifying to the child the source and/or nature of the item. The media player device may present on an image/video screen an image/video representing the adult that sourced or created the item.

The system may allow the adults to control whether the child has choices in sequence or has the ability to play out an item more than a set number of times or has the ability to “rewind” to playout again a portion played out just prior to the “rewind”. By allowing the adults to establish a playout sequence control program, the system allows the adults to set the play priorities in several different ways, such as:
1. Choosing an item to play automatically at a specific time of day and/or date (e.g., a daily wake-up alarm song, or a message or song to be delivered at a specific time).
2. Group the item files into different sub-libraries (shuffle groups or sequential play groups) to play during specific hours (e.g., wake up and play songs in the morning, stories and lullabies in the evening).
3. Include specific items (e.g., messages) to play a specific number of times then automatically delete themselves.
4. Insert items (presumably messages) that automatically jump to the front of the playout queue.

If the hand-held media player includes a microphone and either storage or transmit capability, it may be set by the adult to record replies from the child when the child pushes a button and add those to a “reply library” to be accessed by the adult, or it may be remotely set by the adult to constantly or periodically capture and transmit sounds received at the microphone for real time monitoring or delayed monitoring by the adult via a computer network device or a telephone. If the hand-held media player includes a camera, the replies or monitoring recordings may also include still or motion pictures recorded by the hand-held media player.

The hand-held media player may take the form of a physical picture book that incorporates or is coupled to a recorded sound player and page number sensor circuitry such that the recorded audio for each page of the story plays out the speaker when the book is opened to that page.

### DESCRIPTION OF THE DRAWINGS

The features of the present invention which are believed to be novel are set forth with particularity in the claims as they may be amended. Aspects of the invention may best be understood by making reference to the following description taken in conjunction with the accompanying drawings, wherein:

FIG. 1 is a high level component diagram of the total system.

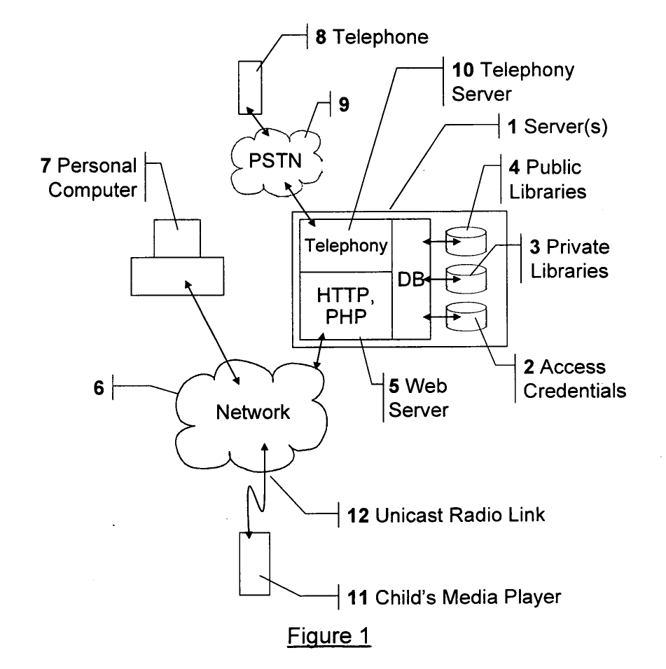

FIG. 2 is a component diagram of the media player used by the child.

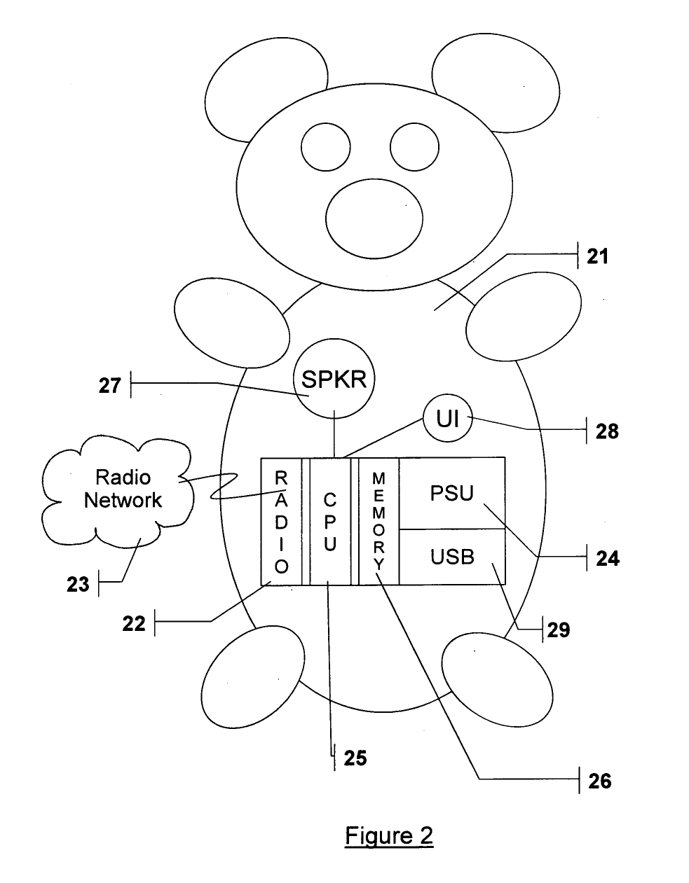

FIG. 3 shows a physical picture book that incorporates or is coupled to a recorded sound player and page number sensor circuitry such that the recorded audio for each page of the story plays out the speaker when the book is opened to that page.

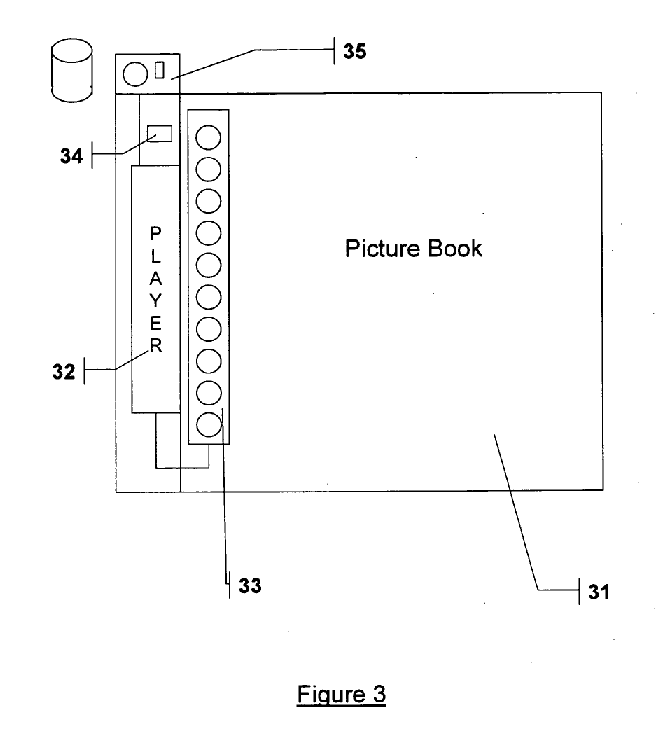

### DETAILED DESCRIPTION

In the following detailed description of exemplary embodiments of the invention, reference is made to the accompanying drawings. The detailed description and the drawings illustrate specific exemplary embodiments by which the invention may be practiced. Other embodiments may be utilized, and other changes may be made, without departing from the spirit or scope of the present invention. The following detailed description is therefore not to be taken in a limiting sense, and the scope of the present invention is defined by the claims as they may be amended.

The invention is a system of components and software centered around a series of private libraries of digital content files (music files, video files, pictures, digital storybooks, and so on) stored on one or more servers 1, where the private libraries of digital content 3 are managed by certain individuals (“controller persons”—presumably adults) for the benefit of other individuals (“recipient persons”—presumably the adults' young children). This private library, called a “soundtrack” is then delivered to the recipient person for their listening and viewing by a variety of possible means, and ideally via a special purpose hand held media player 11 which is specifically adapted to synchronize with the private library content on the server(s).

Server System with Access Controls:

The server or server(s) include a database with a credentials checking component 2 that determines which controller person(s) are allowed to modify a given private library and which private libraries each controller person is allowed to modify. In the preferred embodiment, this database is a MySQL database running on a web server 5 and is accessed via HTML (web) pages that post the user's login credentials from a PC 7 to a PHP script on the web server 5 via an SSL connection over a data network 6 such as the Internet, just as is done on the majority of web sites that incorporate a user login capability. Once logged into the server(s), the person or people managing the library (the “controller person(s)”) are allowed to access and modify the private libraries 3, based on the access rules specified in the access credentials database 2.

Controller persons must enroll in the system by providing an e-mail address and/or user name and a password, just as with most secured web applications. In the preferred embodiment, the controller person's e-mail address is verified by sending an e-mail to them containing a link back to a specific URL on the site and the action of visiting that URL confirms that the e-mail address provided was valid.

Once a controller person is enrolled in the system, he or she can create new private libraries for the benefit of one or more recipient person(s). Having created a new private library, the creating controller person can then use a web form on the site to invite other people to collaborate in filling the new private library with content. The form specifies the name and e-mail address of the invitee and also specifies what kind of access the invitee will be granted (full access, or limited access to do only certain things). The form may also provide the server(s) with other pertinent information such as the relationship of the invitee to the recipient person (e.g. Grandfather), and perhaps the name that the recipient person uses for the invitee (e.g. “Papa” or “Grampa”).

The invitations are sent in the form of an e-mail from the system to the invitee indicating that the inviter would like the invitee to enroll in the system and collaborate on filling up the private library. To accept the invitation, the invitee clicks on a hyperlink in the e-mail and enrolls in the system (or simply logs into the system if he or she has previously enrolled). For added security, the inviter can specify a “challenge question” that the invitee must answer correctly before being granted access to the specific private library in question. The challenge question is something that both individuals would know but a stranger would not know. For example, if the library is for a boy named Tommy and Tommy's mother created the library and then invited Tommy's father to collaborate, the question might be “What is Tommy's favorite food?”, or “Where did you and Tommy go camping last summer?”

In the preferred embodiment, the access rules in the access database may specify that a given controller person may have full access to make unlimited changes to a given library or may have limited access to only perform certain operations (such as only adding items, not deleting or changing sequences, or such as only being able to record a single specific item).

When modifying a library, the controller person(s) can select digital content files from a public library of digital content files 4 that might be for sale or for use free of charge. The controller person(s) can also upload new digital content items (such as uploading an MP3 file). The controller person(s) can also give the server various sequencing instructions as to when and how the items are to be played back. This private library that is created by the controller person(s) is then played back by the recipient person(s) (the child or children), such that the playback experienced by the recipient person(s) is governed by the choices made by the controller person(s) in terms of which items were placed into the recipient's private library and also how those items have been arranged, sequenced, and organized for playback.

The sequencing instructions provided by the controller person(s) can specify a variety of attributes for how and when the digital content items are to be played back. For example, the instructions might:
a) group the content items into multiple sub-collections and where each sub-collection is intended for use during a certain time period, such as wake up songs and stories in the morning; playtime songs, stories, and videos during the day; and bedtime songs, stories and videos at night.
b) specify different play sequence styles for different sub-collections, such as having the wake-up sub-collection and bedtime sub-collection always play start-to-finish but having the playtime sub-collection play out in a round-robin order or random order with one digital content item being played each time the recipient person presses a single button for example,
c) specify that a given digital content item or sub-collection should be automatically played out at a set time of day, as in using the wake-up collection as a morning alarm clock.
d) specify that a given digital content item or sub-collection should be played out at the first opportunity or immediately after a specific time, or based on some action taken by the recipient person. This is useful for including “messages” in the content library, such as a recorded happy birthday message, a message of encouragement to be played out on the morning of some big event in the life of the recipient person, or just an informational message, but the item is only played out when the recipient person pushes a button, as opposed to being played out automatically as in the case of an “alarm” message above.
d) specify that a given digital content item or sub-collection should be played out only once or only a specific number of times, then be removed from the collection or stored for a repeat playout later on. This is useful for messaging capabilities or to specify that the morning sub-collection should only be played once per day before moving on to the playtime sub-collection.

### Integrated Recording Circuit and Creation of Composite Digital Recordings:

In addition to the basic functionality of allowing adults to select and sequence a private library of digital content for playback by children, the system also supports creation of new content items by the controller person(s), such as recording messages (voice or video messages) directly into the library via recording capabilities built into the system. This recording capability is further enhanced by incorporating an ability to have the system mix the user's newly-recorded digital content with pre-existing digital content already on the server. Examples of this latter capability include: a) a parent or grandparent singing a song or reading a storybook for the child and the server mixing the adult's recorded voice with pre-existing music, images and/or sound effects to create a new composite digital content item that presents a more compelling and complete listening experience for the child.

The recording function can be performed through the web interface using a remote device with a microphone and speaker (for example, a PC 7 or an iPhone), coupled via a network connection 6 to standard media server software (for example, Adobe Flash Media Player or Red 5) running on the web server(s) 5. The recorded digital content can be streamed directly to the media server in real time, or can be held locally at the client and uploaded to the web server 5 only after the user is finished recording and re-recording it. While the user is creating a composite item that combines pre-recorded content with new content that the user is recording now, the server displays and/or plays the pre-recorded content to the user so that the user can align the timing of his/her recording with the timing of the pre-recorded content.

For longer pieces such as stories or songs, this process of recording a vocal track to accompany the pre-recorded content is made easier by breaking the recording process into smaller segments. For example, a story book is recorded page-by-page and the user has the opportunity to re-record each page separately. Similarly, a song is recorded verse-by-verse or even phrase-by-phrase so the user has the opportunity to re-record each individual verse or phrase separately. This greatly simplifies the process of capturing a good composite recording and avoids the need for the user to read the whole story or sing the whole song in a single good “take”.

Also, because the system allows multiple users to create recordings via remote interfaces, two or more controller person(s) can collaborate on creating a single composite item, where the recordings of the controller person(s) are created at separate times and places but are then mixed with each other and optionally with pre-recorded content from the public libraries to create a single composite item in the soundtrack. For example, mom and grandma can sing a lullaby in duet or in a round even though they are never in the same place nor online at the same time. Similarly, the parents and grandparents can collaborate in creating a story where one controller person plays the narrator and other controller persons play various characters in the story.

Frequently, when a user creates a recording that is to be mixed with another user's recording and/or with pre-existing digital content, there are certain words the user is expected to say (such as lyrics to a song or words to a story). As an aid to the user, the recording interface displays these words to the user, section-by-section and optionally with a visual indicator (such as a “bouncing ball”) to aid the user in timing.

In the preferred embodiment, the user is allowed to edit the suggested words prior to recording so as to customize the recording. For example, the user might insert the child's name into the lyrics or story or might add a favorite “ad lib” of their own devising. Being able to edit the text prompts prior to recording makes it much easier for the user to remember where these special customizations are meant to go. In some cases, the text customizations may be performed automatically by the server based on information provided to the server(s) by the controller person(s). For example, the server may automatically adjust the text of a story or song to include the names of the controller person(s) and/or recipient person(s), and their relationships.

When a user finishes recording a segment or an entire piece, the user's recorded voice and/or video is then automatically mixed with the pre-recorded content using digital content manipulation software libraries (such as Sox, FFMPeg, Audacity, Xuggle, or Max/MSP). Utilizing the digital content manipulation software tools, the newly recorded content also can be improved prior to being mixed into the composite object in several ways, including:
a) removal of the hiss or noise often associated with PC microphones (by application of a noise reduction filter function)
b) aligning the timing of the user's voice recording with the timing of the pre-recorded content (this is accomplished most simply by removing the leading silence in the vocal recording, then padding the recording with a pre-determined length of pure silence such that the start of the users vocalization is aligned with the correct time in the pre-recorded content)
c) normalizing the gain levels of the vocal recording to match the pre-recorded content
d) adding reverb effect to the vocal recording
e) in the case of singing, the user's recorded song can be pitch-corrected or partially pitch-corrected to match the intended melody using a pitch correction algorithm such as in Celemony Melodyne or Antares Auto-Tune. Such software can also be used to add vocal harmonies at the request of the user.
f) software such as WaveWARM can be used to add analog-style warmth and mellowness to the recording.
g) If the user records a video image of themselves reading a story or singing (as with a web cam), the post-processing system can shrink the video image and mix it with pre-recorded visual content (such as illustrations) so that the recipient person can simultaneously see the pre-recorded visual content, hear the user's voice, and see the user's video image. This experience most closely approximates the controller person actually being present and reading the story or singing the song.

This audio post-processing can be run on the client device or on the server. In the preferred embodiment, the audio post-processing runs on the server for two reasons: a) this avoids the need for the user to download the audio processing software from the server, and b) this makes the same audio post-processing process available for recordings captured over the Public Switched Telephone Network (PSTN) rather than at a PC. In either case, the primary requirement is that the post-processing be fully automated. This way, the user needn't have any understanding of audio post-processing or audio engineering. The post-processing runs automatically and the user's input is limited to a very few simple questions such as “do you want to add harmony”?

In the preferred embodiment, a controller person is also allowed to access the servers and modify a private library via a telephone interface. This is accomplished most simply by interfacing a telephony server 10 (such as Asterisk, Trixbox, or a Pronexus VBVoice server) into the library and database server(s).

In one mode of telephone operation, the user uses a telephone 8 to dial the telephony server 10 via the Public Switched Telephone Network 9, and enters telephone access credentials such as those used to access a voice mail system. The user is then prompted through the process of creating a recording (or composite recording) for the library via an Interactive Voice Response (IVR) interface within the telephony server. This mode is most useful for including individual collaborators who are not PC-literate or who do not have access to a PC or the Internet.

In another mode of operation, the user can be logged into the web site 5 from a PC 7 and use the web pages to manipulate the library, but use a telephone 8 as a speaker and microphone for purposes of playing and recording. In this case, the user's commands are input to the system via the web interface and then routed from the web server to the relevant channel on the telephony server 10. A one-to-one association between the user's web session and their telephony session can be established either by a) displaying on the web interface a number for the user to call and a password to enter or by b) having the user call the telephony server 10 and enter their telephone access credentials, or by c) having the telephony server 10 call the user's phone and optionally prompt them for a password. This mode of telephony operation is advantageous for users who have access to a PC and Internet but either do not have a microphone on their PC or just prefer using the telephone to record.

As yet another alternative for customizing the digital content in the private libraries, the controller person(s) may be allowed to submit textual content to the servers (either via a web interface or via an e-mail interface or via some other text messaging interface such as SMS). The system can use commercially available text-to-speech software residing either on the server(s) or on the media player to convert the text content into audio content for playback to the recipient person(s).

### Delivery of Soundtacks and Synchronization to Player Device:

The process of uploading, recording, and organizing the private library of digital content may take some time, especially if there are multiple controller person(s) involved in the process. In order to avoid the awkwardness of having the recipient person receive incomplete items, the system includes a method for a controller person to indicate that the private library (or “soundtrack”) is ready for delivery. This can take the form of an online checkout process as is common in most web-based stores. During that checkout process the controller person may also:
a) pay for the pre-recorded digital content they have selected and/or pay for the use of the recording circuit and mixing tools used to create the soundtrack(s).
b) specify the method or means of delivery of the soundtrack(s).

Once the soundtrack has been created and/or sequenced by the controller person(s) and is deemed ready for consumption by the recipient person, the collection is transmitted to the recipient person(s) by several possible means, including:
a) the preferred embodiment (described below)
b) delivery on a physical storage media such as a CD, DVD, SDcard, or memory stick.
c) delivery via the Internet to a dedicated application on a PC or smart phone, or to an e-mail in-box, or to a web interface customized for use by recipient person(s) to receive the pre-selected, pre-sequenced, customized digital content, and to play back that content in accordance with the sequencing or organization instructions specified by the controller person(s).
d) Delivery over the PSTN by having the telephony server call the recipient person and play the soundtrack, optionally at a specified time.
e) delivery in the form of a physical picture book 31 that incorporates or is coupled to a recorded sound player 32 and page number sensor circuitry 33 such that the recorded audio for each page of the story plays out the speaker 34 when the book is opened to that page. The page number sensor circuitry 33 can be implemented in a variety of ways. One embodiment consists of a series of small switches (magnetic switches, optical switches, electronic switches, or mechanical switches) incorporated into the construction of the book so that as the pages are turned, each switch is either opened or closed in turn (depending on which type of switch is used and which way they are oriented). In another embodiment, the switching effect can also be implemented using a single sensor that senses the position of all the pages (for example, a Hall Effect sensor combined with magnets placed in the pages or an optical sensor that can detect how many pages are “closed’ based on holes drilled in each page). Regardless of the mechanism employed, the turning of each page creates a signal to the media player module indicating which page the book is open to and therefore which digital content item should be played. The digital content item could be a recording of an adult reading that particular page of the story (optionally enhanced with pre-recorded sound effects), or it might be a person or person(s) “narrating” the pages of a physical photo album. In the preferred embodiment, the page location sensor circuitry is accomplished with a series of small switches consisting of two small flat contacts on each odd page and one longer flat contact on each even page such that when a page is “closed” the contact close and a circuit is closed and when the book is opened to a particular page, the contacts are separated and the “switch” for that page is opened. The simple “switches” can be placed near to the spine of the book so that each switch is only activated when the book is fully opened to that page. The switches can be physically arranged along the page such that each switch can only be actuated by its partner half when one specific page is turned. The pages can be stiffened sufficiently to ensure that the switches are in fact opened and closed as the pages are turned. It is also desirable for the media player to delay playing the sound for a particular page until the page is fully turned and the preceding switch is closed. The physical picture book may also have a local digital voice recorder capability as well. A reader can use the play/record switch 34 to put the book into record mode, then record the story page by page simply by turning the pages and speaking into an attached or inbuilt microphone 35. In one embodiment, this is the only method for recording the book. The reader can also place the play/record mode switch 34 into play mode to listen to each page after it is recorded and optionally place the switch back to record mode to re-record the page. For convenience, the switch 34 can be implemented as momentary pressure switch which is placed inside a protective housing to prevent accidental activation of the switch. Each time the switch 34 is placed into record mode, the media player can play a brief introductory prompt before starting the recording and the introductory prompt can optionally include instructions which may be specific to the page being recorded. Recording can end either when the reader places the switch back into play mode (by releasing the pressure switch) or when the reader stops speaking and the recorder detects silence. The switch also may have a disabling feature to prevent accidental re-recording of the book once the recording is complete.

In the preferred embodiment, the library of digital content items is automatically transmitted by the servers via a radio link 12 (such as a cell phone network or a Wi-Fi or Wi-Max network) to a media player 11 that is specifically adapted to accept the content items and associated sequencing instructions from the servers and which includes a simplified user interface that allows the child to play back the library, within the parameters set by the controller person(s). We refer to this transmission as ‘unicast’ because the private library of digital content is intended specifically for the user of that particular media player, and not for consumption by any other people (as might be the case for example with a public radio broadcast). In the case of this preferred embodiment, where the delivery to the recipient person is automatically accomplished via unicasting, the controller person might indicate that a given soundtrack or digital content item is complete and ready for delivery either by marking the item as finished in the web interface or simply by adding a new digital content item and ending his/her session with the server(s).

In addition to being specifically adapted to automatically synchronize via radio with the private library servers, the media player should have speakers and may also have other play factors. For example:
a) it might be embedded in a teddy bear or other cuddle object 21.
b) it might play small “interstitial comments” between the digital content items from the private library, and these “interstitial comments'”might give the media player the appearance of having a personality. The interstitial comments might be stored in non-volatile memory 26 on the media player or they might be added into the sequence of items by the server. The interstitial comments can be pre-recorded items that are automatically added by the player or by the server or they can be items that were recorded by the controller person(s) and stored on the server(s) for use specifically as interstitial comments. (In other words, the controller person(s) can optionally re-record the interstitial comments in order to modify the “personality” created by the interstitial comments.) The interstitial comments can be used merely to give the appearance of personality and/or to provide background information about the other digital content such as which controller person provided and/or recorded the next digital content item.
c) it might have an ability to detect the presence of another player in the immediate proximity (via methods such as cellular, wi-fi, wi-max, or bluetooth), and the two players (each with an apparent personality) might interact with each other by “speaking to each other” for the amusement and entertainment of the children.
d) It might have an inbuilt accelerometer (such as are built into modern smart phones like the iPhone) and it might use this accelerometer to detect when it is layed down or picked up or thrown or swung, and these actions might then impact the behavior of the player's “personality”.

In the preferred embodiment, this media player is a purpose-built electronic device designed specifically for this application and therefore optimized for lowest possible manufacturing cost. However, the player could be implemented using any off-the-shelf cell phone that incorporates a media player and supports application programming (such as in Java). Examples of off-the-shelf phones that could be adapted to this purpose include the Google Android G1 from HTC (T-Mobile), the Apple iPhone, or the RIM Blackbery Pearl or Storm. All of these phones include:
a) a CPU 25 with media player software and sufficient programmability to enable the device to be converted from a general purpose cell phone and media player into a specially adapted media player with automatic wireless synchronization to the private library(ies) on the server(s).
b) non-volatile memory 26 to store instructions and digital content
c) one or more speakers 27
d) a variety of user interface capabilities 28
e) radio circuitry 22 to connect to a wireless data network 23 and thence to the server(s) holding the private library,
f) a battery power supply 24, and
g) a USB connection 29 for charging the battery and to enable USB-based synchronization and programming.

While an off-the-shelf programmable smart phone has the necessary hardware elements to implement the invention, the software must be heavily modified to implement the automatic wireless synchronization and the hardware platform is not optimal for the preferred embodiment of a lower cost device embedded in a child's plaything.

### Linkage Between Player and Server to Enable Automatic Wireless Synchronization

Important to the functioning of the overall system is a persistent linkage between the media player and one or more private libraries on the server(s). This linkage is established as an initialization process and remains stored in non-volatile memory on both the server and the media player such that the digital content and sequencing instructions stored on the player can be automatically updated on a continual or periodic basis to match the digital content and sequencing instructions stored in the private library(ies) on the server(s) (“automatic wireless synchronization”).

In the preferred embodiment, to reduce the cost of the media player, the player has a very minimal user interface which is not capable of allowing a user to enter access credentials. In this case, the linkage is established by the controller person entering into the servers (via the web interface) a unique identifying code associated with the player (for example, a MAC address, or mobile phone number or SIM card number or serial number or other such identifier). In the preferred embodiment, to enhance security, the controller person may enter a unique hardware-based identifier as well as a security key number that is packaged with the player. The security key number could be a serial number that is programmed into the unit at the factory and stored in non-volatile memory on the unit, or it could be simply an algorithmic hash of the hardware-based identifier where the hashing algorithm is known to both the server and the player. The software on the player periodically connects to the radio network and thence to the server(s), and presents its built-in access credentials. Once the player's access credentials are received and verified, the server transmits to the player (via the unicast radio link) all of the necessary information to enable the player to update its internally stored content to match the content of the private library(ies) to which the player has been linked.

In the preferred embodiment, the media player is a hand-held battery powered device. In order to maximize battery life on the media player, the automatic synchronization process runs periodically in the background on the player, the digital content and sequence instructions are downloaded and stored on the player, and the radio circuitry in the player is automatically switched off when the synchronization process is not running.

In the preferred embodiment, to reduce cost, the user interface on the media player is kept extremely simple and easy enough for a small child to use. For example, the interface may consist of a single button and a single lamp where,

1. A method for a controller person to control selection and sequence of content items for possible playout on a digital recorded sounds player used by a recipient person and served via a unicast radio link, comprising:
a. having a hand-held digital recorded sounds player comprising a radio digital data receiving circuit, a digital content item playout circuit, a playout speaker, and at least one user playout control;
b. having a unicast radio communication link from one or more personal content servers to the radio digital data receiving circuit;
c. having on the servers an access credentials checking circuit coupled to a store of credentials checking data;
d. receiving at an input on the servers, from a source that is not the recorded sounds player, a request for access with offered access credentials;
e. using the credentials checking circuit and credentials checking data to check the offered access credentials; and
f. if the credentials qualify, in response to receipt of instructions specifying at least two content items and instructions unique to the recipient person specifying a sequence in which the items are to be played⁻out on the recorded sounds player, unicast transmitting via radio a copy of each of said content items from the servers to the recorded sounds player for possible play out in the specified sequence.

2. The method of claim 1 where the servers accept sequence instructions from the source that is not the recorded sounds player provided via a public telephone system.

3. The method of claim 1 where the servers accept sequence instructions from the source that is not the recorded sounds player provided via a publicly accessible computer network.

4. The method of claim 1 where the servers are on a personal computer and accept sequence instructions from the source that is not the recorded sounds player provided via input to the personal computer.

5. The method of claim 1 where the radio communication link operates via a cellular mobile telephone system.

6. The method of claim 1 where the radio communication link operates via a wide area wireless data network.

7. The method of claim 1 where the communication link operates via a computer network from the servers to a local computer network radio antenna to the recorded sounds player.

8. The method of claim 1 where the recorded sounds player comprises a digital content items storage memory and the content items are stored in the memory prior to play out.

9. The method of claim 1 where the content items are streamed from the servers to the recorded sounds player at the time of play out.

10. The method of claim 1 where the recorded sounds player has video playout capability and the content items comprise audio and video.

11. The method of claim 1 where the playout sequence instructions cause a content item to be deleted from the item storage memory once the item has been played one or more times.

12. The method of claim 1 where the playout sequence instructions cause a content item to be played out at a set time of day.

13. The method of claim 1 where the sequence instructions cause the content items to be grouped into multiple sub-collections and where each sub-collection is then played in a round-robin order or random order during certain hours of the day.

14. The method of claim 1 where the recorded sounds player is embedded within a plush toy.

15. The method of claim 1 where the recorded sounds content items are selected, via input from the source that is not the recorded sounds player, from a library of digital content items on the one or more servers.

16. The method of claim 1 where at least one of the digital content items is provided to the one or more servers upon approval of the access credentials.

17. The method of claim 16 where at least one of the digital content items is a voice message recorded by the one or more servers from the source that is not the recorded sounds player via a real time audio telephone link.

18. The method of claim 16 where at least one of the digital content items is an audio and/or video recording recorded in real time by the one or more servers from the source that is not the recorded sounds player via a personal computer or handheld communication appliance connecting to the one or more servers over a computer network or wireless data network.

19. The method of claim 1 where at least one of the digital content items comprises music, sound effects, and/or images selected from the library stored on the one or more servers combined with a voice recording from the source that is not the recorded sounds player or from the library, as in a recorded karaoke performance or a recording of the reading of an illustrated story.

20. The method of claim 1 where at least one of the digital content items comprises an audio recording accompanied by one or more still digital images.

21. The method of claim 1 where at least one of the digital content items comprises a text-to-speech voice file created from a textual message sent to the one or more servers from the source that is not the recorded sounds player.

22. The method of claim 1 where some or all of the digital content items are automatically introduced with interstitial comments automatically selected and played by the handheld recorded sounds player.

23. The method of claim 22 where the interstitial comments identify the person who provided or created the digital content item.

24. The method of claim 1 where the controller person can authorize additional controller persons to deposit or modify content items or the sequencing instructions on the server.

25. The method of claim 24 where each additional controller person has separate access credentials for purposes of connecting to the one or more servers to deposit or modify contents items or the sequencing instructions on the server.

26. A method for a controller person to create customized soundtracks for delivery to a recipient person comprising:
a. having one or more servers storing one or more libraries of previously created digital content from which specific digital content items can be selected by the controller person;
b. having on the servers an access credentials checking circuit coupled to a store of credentials checking data which, when the controller person presents qualifying credentials, allows the controller person to select some of the digital content items into a grouping of digital content items and to sequence the items within the grouping for play-out to a recipient person on a recorded sounds player;
c. having connected to the one or more servers a digital content recording circuit that is not the recorded sounds player and allows the controller person to record a new digital content item and place it onto the servers and into a grouping along with one or more pre-recorded digital content items selected and sequenced for play-out to a recipient person; and
d. having on the one or more servers an order processing system that allows the controller person to order the finished grouping of digital content items to be delivered for play-out to the recipient person.

27. The method of claim 26 where the digital content recording circuit captures new recorded sounds transmitted to the servers via a public telephone system.

28. The method of claim 26 where the digital content recording circuit captures new recorded sounds transmitted to the servers from a remote recording device via a publicly accessible computer network.

29. The method of claim 26 where the servers are on a personal computer and the digital content recording circuit captures new recorded sounds transmitted to the servers via input to the personal computer.

30. The method of claim 26 where delivery of the grouping of digital content items is accomplished by physical delivery of a compact disc, digital video disk,memory stick, SD card, or other physical memory.

31. The method of claim 26 where delivery of the grouping of digital content items is accomplished by downloading the grouping of digital content items over a computer network to the recorded sounds player.

32. The method of claim 31 where the downloading is performed by e-mailing the grouping of digital content items.

33. The method of claim 31 where delivery of the grouping of digital content items is accomplished by transmitting the grouping of digital content items to the recorded sounds player via radio transmission coupling of the player to a computer network over which the grouping of digital content items is downloaded.

34. The method of claim 31 where the recorded sounds player comprises a digital content items storage memory and the content items are stored in the memory prior to play out.

35. The method of claim 31 where the content items are streamed from the servers to the recorded sounds player at the time of play out.

36. The method of claim 26 where the recorded sounds player has video playout capability and the content items comprise audio and video.

37. The method of claim 26 where the playout sequence instructions cause a content item to be deleted from the item storage memory once the item has been played one or more times.

38. The method of claim 26 where the playout sequence instructions cause a content item to be played out at a set time of day.

39. The method of claim 26 where the sequence instructions cause the content items to be grouped into multiple sub-collections and where each sub-collection is then played in a round-robin order or random order during certain hours of the day.

40. The method of claim 26 where the recorded sounds player is embedded within a plush toy.

41. The method of claim 31 where the delivery of the grouping of digital content items is accomplished by an automatic synchronization process between the servers and the recorded sounds player.

42. The method of claim 31 where the delivery of the grouping of digital content items is accomplished via periodic electrical coupling of the recorded sounds player to a personal computer or computer network.

43. The method of claim 26 where at least one digital content item comprises music, sound effects, or images selected from the library stored on the one or more servers combined with a voice or video recording captured by the digital content recording circuit.

44. The method of claim 43 where combination of the digital content from the library with the newly recorded digital content is accomplished via digital content mixing software and/or circuitry operating within the digital content recording circuit or on the servers.

45. The method of claim 43 where the digital content recording circuit is resident on an electronic device that is remote from the servers and where combination of the digital content from the library and the newly recorded digital content is accomplished via digital content mixing software or circuitry operating on the electronic device.

46. The method of claim 43 where the selected digital content is a series of images or moving pictures, optionally with sound effects, and the voice or video recording is of the controller person narrating a story that goes along with the selected digital content.

47. The method of claim 26 where the digital content recording circuit captures the new digital content in sections, then combines the sections into a single composite item.

48. The method of claim 26 where at least one of the digital content items comprises a text-to-speech voice file created from a textual message sent to the one or more servers from the digital content recording circuit that is not the recorded sounds player.

49. The method of claim 26 where some or all of the digital content items are automatically introduced with interstitial comments automatically selected and played by the recorded sounds player.

50. The method of claim 49 where the interstitial comments identify the controller person who provided or created the digital content item.

51. The method of claim 49 where the interstitial comments are digital content items recorded by one or more controller persons via the digital content recording circuit.

52. The method of claim 26 where the controller person can authorize additional controller persons to deposit or modify digital content items or sequencing instructions.

53. The method of claim 52 where the additional controller persons each have separate access credentials for purposes of connecting to the one or more servers to deposit or modify the digital contents items or sequencing instructions.
